(19) United States
(12) Patent Application Publication
(10) Pub. No.: US 2007/0207796 A1
(43) Pub. Date: Sep. 6, 2007

(54) Wireless voice operated system and method for portable communication device and wireless earphones thereof

(75) Inventor: Bin Yan, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/702,534

(22) Filed: Feb. 6, 2007

(30) Foreign Application Priority Data
Mar. 2, 2006 (TW) 095106936

(51) Int. Cl. H04M 3/00

(52) U.S. Cl. 455/420

(57) ABSTRACT

A wireless voice operated system comprises wireless earphones and a portable communication device, wherein the wireless earphones connected to the portable communication device via a wireless transmission comprises a voice receiver, a voice transmitter, a control unit, and a press key portion. If the press key portion is pressed to send an instruction signal to the portable communication device, the portable communication device will receive the instruction signal and start waiting for a voice content received by the voice receiver, and the control unit will send the voice content to the portable communication device, and then the portable communication device will execute a function module in the portable communication device corresponding to the voice content after the voice content is compared and confirmed, so that the wireless earphones can operate the functions of the portable communication device at a remote end, without the need to manually operate the portable communication device.

### FIELD OF THE INVENTION

The present invention relates to a wireless voice operated system and method for a portable communication device, and more particularly to a wireless voice operated system and method for a portable communication device via wireless earphones.

### BACKGROUND OF THE INVENTION

Modern society is facing a high-technological information era with advances in electronics; various technologically advanced electronic products derived from digital technologies are developed speedily while various electronic elements and peripheries are also continuously developed. All of which are closely related and essential for work and everyday living, contributing to the advances of the electronics industry. Meanwhile, development trends as described above not only speeds up the efficiency of information transmissions, but also increases the convenience of daily life and work for people. However, following the research and development of various electronic technologies, consumers are paying more attention to utility, practicability, applicability, and convenience of the electronic technologies to satisfy their needs.

For earphones, many commercially available electronic devices are provided with a function using the communication protocol of wireless earphones, such as Bluetooth, wherein a conventional wireless Bluetooth earphone device comprises a radio-frequency module, a receiver/transmitter, a Bluetooth chip, a memory unit, a pair of earphones, and a microphone. The Bluetooth chip is used to communicate related information stored in the memory unit between the receiver/transmitter and an external electronic device using Bluetooth technology via radio-frequency module. Once the wireless Bluetooth earphones built up a common communication protocol with the external electronic device, the wireless Bluetooth earphone device will exchange voice content data between the receiver/transmitter and the external electronic device via the radio-frequency module. For example, when a user uses a mobile phone with the wireless Bluetooth earphones during driving or riding, the user can answer the phone by using an auto-answer function of the wireless Bluetooth earphones to answer without manually taking the mobile phone out of a bag or clothes or holding the mobile phone. However, when the user wants to make a phone call, the user has no choice but to manually take the mobile phone out of a bag or clothes and hold the mobile phone to make a phone call regardless of the inconvenience. As a result, the user must suspend or slow an initial activity, such as driving or riding, while spending a considerable time to make a phone call or find a phone number from a phone book of the mobile phone with confusion, thus causing inconvenience.

It is therefore tried by the inventor to develop a wireless voice operated system and method for a portable communication device and wireless earphones thereof to solve the problems existing in conventional wireless electronic products as described above.

### SUMMARY OF THE INVENTION

A primary object of the present invention is to provide a wireless voice operated system for a portable communication device, which is provided with wireless earphones and a portable communications device, the wireless earphones comprises a voice receiver, a voice transmitter, a control unit, and a press key portion, if the press key portion is pressed to send an instruction signal to the portable communication device wirelessly connected to the wireless earphones, the portable communication device will compare/confirm a voice content received by the voice receiver, and execute a function module in the portable communication device corresponding to the voice content, so that the wireless earphones can operate the functions of the portable communication device at a remote end, without manually operating the portable communication device.

A secondary object of the present invention is to provide a wireless voice operating method for a portable communication device via wireless earphones, comprising steps of: providing the wireless earphones having a voice transmitter formed thereon, a voice receiver formed thereon for sending at least one voice content into the wireless earphones, a wireless transmission module formed therein and wirelessly connected to the portable communication device for sending at least one voice message to the portable communication device, and a control unit formed therein and respectively connected to the voice transmitter, the voice receiver, and the wireless transmission module for controlling all of them, while the control unit is used to receive at least one voice message and send it to the portable communication device via the wireless transmission module; providing the portable communication device having a memory unit, a wireless transmission portion, and a central processor, wherein the memory unit includes a keyword database, a voice command program, and a plurality of function modules, the keyword database is preset with a plurality of keywords for respectively starting the function modules, the voice command program is used to convert each of the keywords into a corresponding voice command for starting the function modules, wherein the wireless transmission portion is wirelessly connected to the wireless earphones for receiving at least one voice content, and wherein the central processor is used to compare and confirm each of the voice content with each of the keywords, and then the voice command program starts the corresponding function module by the voice command converted from the keyword matched with the voice content.

A third object of the present invention is to provide wireless earphones applied to a wireless voice operated system for a portable communication device, which is provided with a voice transmitter formed thereon, a voice receiver formed thereon for collecting and sending at least one voice message to the wireless earphones, a wireless transmission module formed therein and wirelessly connected to the portable communication device for sending at least one voice message to the portable communication device, a press key portion formed thereon and used to be pressed to send an instruction signal which is converted into a transmission signal via the wireless transmission module to the portable communication device, and a control unit formed therein and respectively connected to the voice transmitter, the voice receiver, the wireless transmission module, and the press key portion for controlling all of them, while the control unit is used to receive the transmission signal and at least one voice message, and send the transmission signal and at least one voice message to the portable communication device via the wireless transmission module.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a wireless voice operated system for a portable communication device via wireless earphones according to a preferred embodiment of the present invention;

FIG. 2 is a flowchart of a wireless voice operating method for a portable communication device via wireless earphones according to a first preferred embodiment of the present invention;

FIG. 3 is a flowchart of a wireless voice operating method for a portable communication device via wireless earphones according to a second preferred embodiment of the present invention;

FIG. 4 is a flowchart of a wireless voice operating method for a portable communication device via wireless earphones according to a third preferred embodiment of the present invention;

FIG. 5 is a flowchart of a wireless voice operating method for a portable communication device via wireless earphones according to a fourth preferred embodiment of the present invention;

FIG. 6 is a flowchart of a wireless voice operating method for a portable communication device via wireless earphones according to a fifth preferred embodiment of the present invention; and

FIG. 7 is a flowchart of a wireless voice operating method for a portable communication device via wireless earphones according to a sixth preferred embodiment of the present invention.

### DETAILED DESCRIPTION OF THE PREFERRED EMBODIMENTS

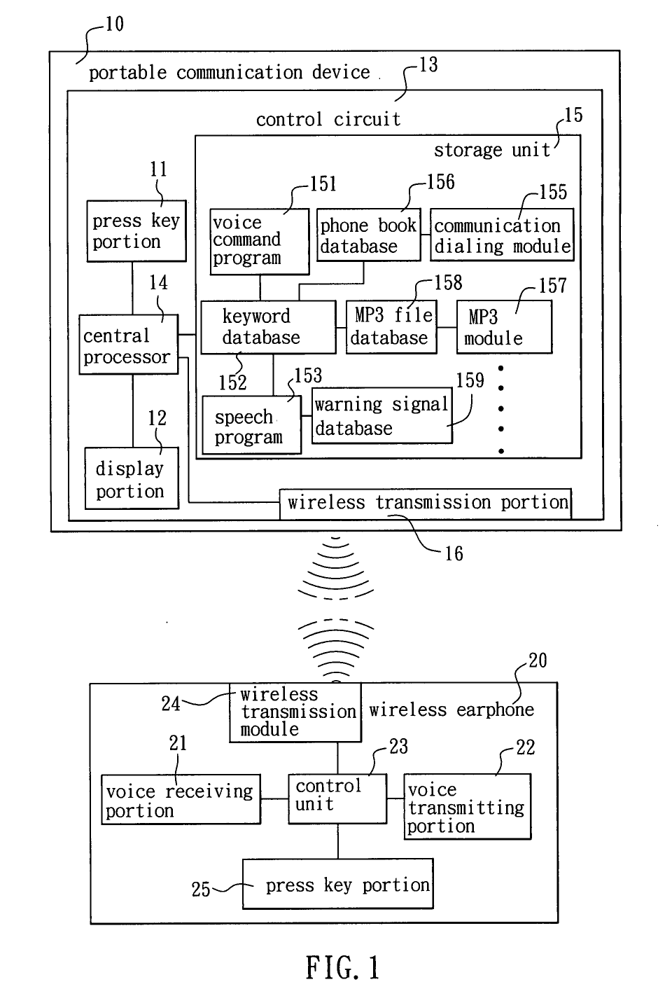

Referring now to FIG. 1, a wireless voice operated system and method for a portable communication device and wireless earphones thereof according to a preferred embodiment of the present invention are illustrated. As shown, the wireless voice operated system comprises a portable communication device 10, such as mobile phone, personal digital assistant (PDA), and etc., which is provided with a press key portion 11, a display portion 12, and a wireless transmission portion 16. The press key portion 11 is used to start the portable communication device 10, and to operate various functions (i.e. video function, audio function, or communication function) of the portable communication device 10 by viewing the display portion 12. The portable communication device 10 is further provided with a control circuit 13 and a central processor 14 (CPU) for electrically connecting the press key portion 11, the display portion 12, and the wireless transmission portion 16, as shown in FIG. 1, so that the central processor 14 could control all of them.

Referring back to FIG. 1, in another preferred embodiment of the present invention, the control circuit 13 of the portable communication device 10 is preferably formed with a storage unit 15 (i.e. hard disk, HD) which includes a voice command program 151, a keyword database 152, a speech program 153, and a plurality of function modules, such as a communication dialing module 155 and a MP3 module 157. The keyword database 152 is preset with a plurality of keywords. The voice command program 151 is used to convert each of the keywords into a corresponding voice command for starting the communication dialing module 155 and a MP3 module 157. The speech program 153 is used to convert word data stored in the portable communication device 10 into a corresponding produced voice, and output the produced voice from the portable communication device 10.

Referring back to FIG. 1, in further another preferred embodiment of the present invention, the wireless voice operated system further comprises wireless earphones 20 which is provided with a voice receiver 21 (i.e. microphone), a voice transmitter 22 (i.e. speaker), a control unit 23 (i.e. Bluetooth controller), a wireless transmission module 24 (i.e. RF module), and a press key portion 25 (i.e. keypad). When the wireless earphones 20 is wirelessly connected to the portable communication device 10 and the press key portion 25 is pressed, the press key portion 25 will send an instruction signal to the control unit 23, and then the wireless transmission module 24 converts the instruction signal into a transmission signal which is sent to the wireless transmission portion 16 of the portable communication device 10. After this, the central processor 14 receives the instruction signal (i.e. the transmission signal), and then executes the voice command program 151. The voice command program 151 starts to process at least one voice message previously received by the voice receiver 21 for starting one of the function modules of the portable communication device 10. The central processor 14 compares the voice content with the keyword stored in the keyword database 152 to confirm if the voice content matches with one of the keywords via the voice command program 151. If so, the voice command program 151 inputs the voice command to start the corresponding function module matched with the keyword. Meanwhile, the speech program 153 generates a produced voice transmitted back to the voice transmitter 22 of the wireless earphones 20 for notifying a function status of the portable communication device 10 to a user, so that the user can operate the functions of the portable communication device 10 at a remote end via wireless earphones 20, without manually operating the portable communication device 10.

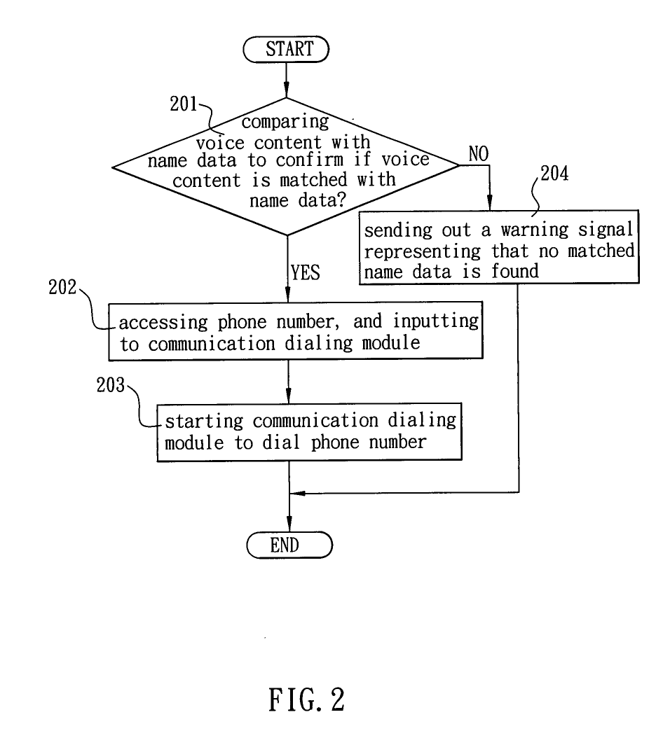

Referring back to FIG. 1, in a first preferred embodiment of the present invention, the wireless earphones 20 can be actuated by directly receiving a name voice preset in the wireless earphones 20 so to wirelessly drive the portable communication device 10 for conveniently making a phone call. The portable communication device 10 further comprises a phone book database 156 connected to the communication dialing module 155. The phone book database 156 substantially stores at least one name data (not shown), at least one phone number (not shown) corresponding to the name data, wherein the keywords are preferably selected from a plurality of voices matched with the name data, respectively. When the press key portion 25 is pressed, the voice receiver 21 receives a voice message, and then the voice content is transmitted to the portable communication device 10 via the wireless transmission module 24. As shown in FIG. 2, there are further several steps described more detailed as follows:

In step 201, the central processor 14 compares the voice content with name data to confirm if the voice content matches with name data; if yes, go to step 202; if not, go to step 204;

In step 202, the voice command program 151 accesses a phone number of the name data based on a voice command converted from the voice content, and inputs the phone number to the communication dialing module 155;

In step 203, the central processor 14 starts the communication dialing module 155 to dial the phone number; and

In step 204, the voice command program 151 sends out a warning signal representing that no matched name data is found via the voice transmitter 22.

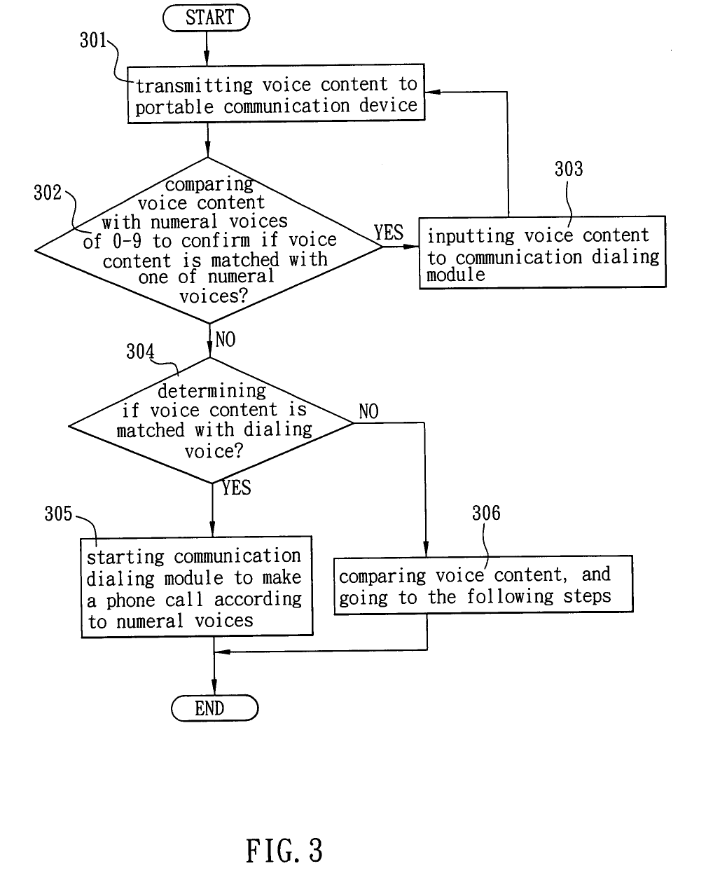

Referring back to FIG. 1, in a second preferred embodiment of the present invention, the wireless earphones 20 can directly receive voice contents of phone numbers, and then drive the communication dialing module 155 to dial the phone numbers, wherein the keywords are further selected from the group consisting of voice samples from 0 to 9, and a dialing voice. When the press key portion 25 is pressed and the voice command program 151 is executed, there are further several steps described more detailed as the following and shown in FIG. 3:

In step 301, the voice receiver 21 receives a voice message, and transmits the voice content to the portable communication device 10;

In step 302, the central processor 14 compares the voice content with the voice samples of 0-9 to confirm if the voice content is matched with one of the voice samples; if yes, go to step 303; if not, go to step 304;

In step 303, the voice command program 151 inputs the voice content to the communication dialing module 155, and then go back to step 301 for receiving another voice message;

In step 304, the central processor 14 determines if the voice content is matched with the dialing voice; if yes, go to step 305; if not, go to step 306;

In step 305, the voice command program 151 starts the communication dialing module 155 to make a phone call according to the numeral stored in the communication dialing module 155; and

In step 306, the central processor 14 compares the voice content, and goes to the following steps.

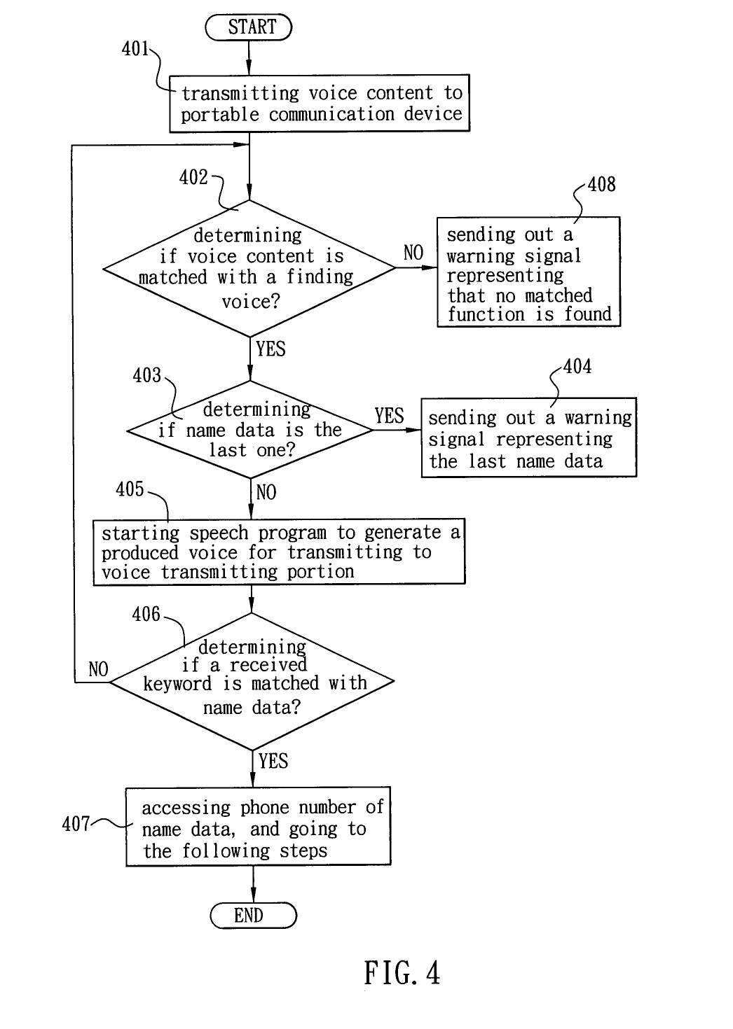

Referring back to FIG. 1, in a third preferred embodiment of the present invention, the wireless earphones 20 not only can be used to wirelessly drive the communication dialing module 155 of the portable communication device 10 to make a phone call, but also can be used to wirelessly find the name data stored in the phone book database 156. Then, the speech program 153 can be used to convert the name data of the phone book database 156 into a corresponding produced voice in turn, wherein the keywords are preferably selected from a finding voice. When the press key portion 25 is press and the voice command program 151 is executed, there are further several steps described more detailed as the following and shown in FIG. 4:

In step 401, the voice receiver 21 receives a voice content, and then the voice content is transmitted to the portable communication device 10;

In step 402, the central processor 14 determines if the voice content is matched; if yes, go to step 403; if not, go to step 408;

In step 403, the speech program 153 determines if the name data of the phone book database 156 is the last one; if yes, go to step 404; if not, go to step 405;

In step 404, the voice command program 151 sends out a warning signal representing the last name data is accessed via voice transmitter 22;

In step 405, the voice command program 151 starts the speech program 153 to generate a corresponding produced voice according to the name data of the phone book database 156, and the produced voice is transmitted to the voice transmitter 22;

In step 406, the central processor 14 determines if the voice receiver 21 receives a keyword matched with the name data; if yes, go to step 407; if not, go to step 403;

In step 407, the voice command program 151 accesses the phone number of the name data, and goes to the following steps; and

In step 408, the voice command program 151 sends out a warning signal representing that no matched function is found via the voice transmitter 22.

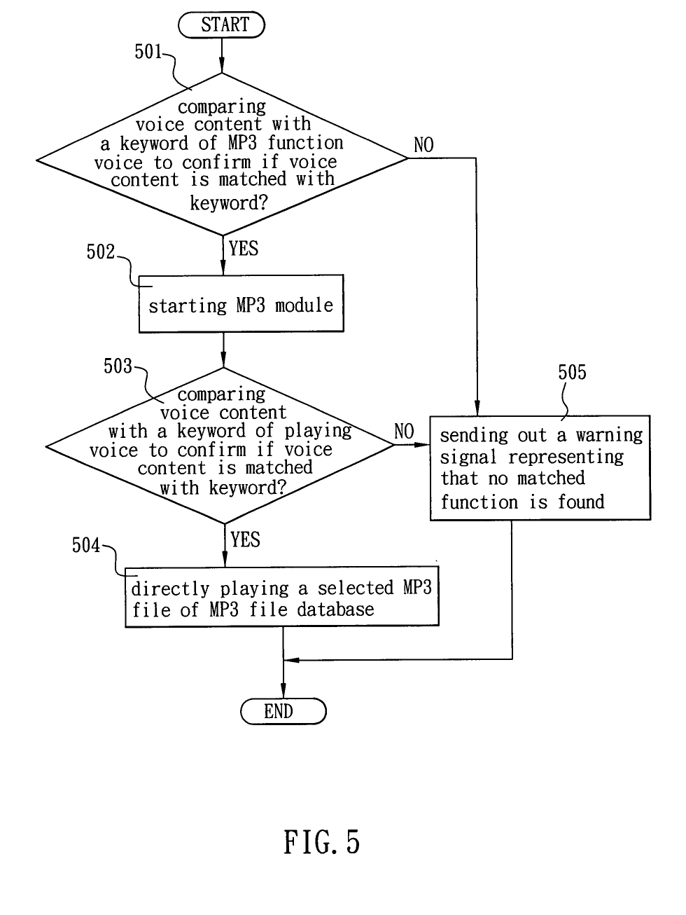

Referring back to FIG. 1, in a fourth preferred embodiment of the present invention, the wireless earphones 20 can be used to directly receive a preset file voice to wirelessly drive the portable communication device 10 to directly play an MP3 file. The portable communication device 10 further comprises a MP3 module 157, and a MP3 file database 158 connected between the MP3 module 157 and the keyword database 152. The MP3 file database 158 is preset with at least one MP3 filename (not shown), and at least one MP3 file path for accessing the corresponding MP3 filename (not shown). The keywords are preferably selected from the group consisting of a communication dialing voice, a MP3 function voice, a playing voice, and at least one MP3 filename voice corresponding to at least one MP3 filename. When the press key portion 25 is pressed and started, the voice receiver 21 receives a voice content which is further transmitted to the portable communication device 10. Then, there are further several steps described more detailed as the following and shown in FIG. 5:

In step 501, the central processor 14 compares the voice content with a keyword of the MP3 function voice to confirm if the voice content is matched with the keyword thereof; if yes, go to step 502; if not, go to step 505;

In step 502, the voice command program 151 converts the voice content into a voice command to start the MP3 module 157;

In step 503, the central processor 14 compares voice content with a keyword of the playing voice to confirm if the voice content is matched with the keyword; if yes, go to step 504; if not, go to step 505;

In step 504, the MP3 module 157 directly plays a selected MP3 file of the MP3 file database 158, and finishes the MP3 procedure; and

In step 505, the voice command program 151 sends out a warning signal representing that no matched function was found via the voice transmitter 22, and finishes the MP3 procedure.

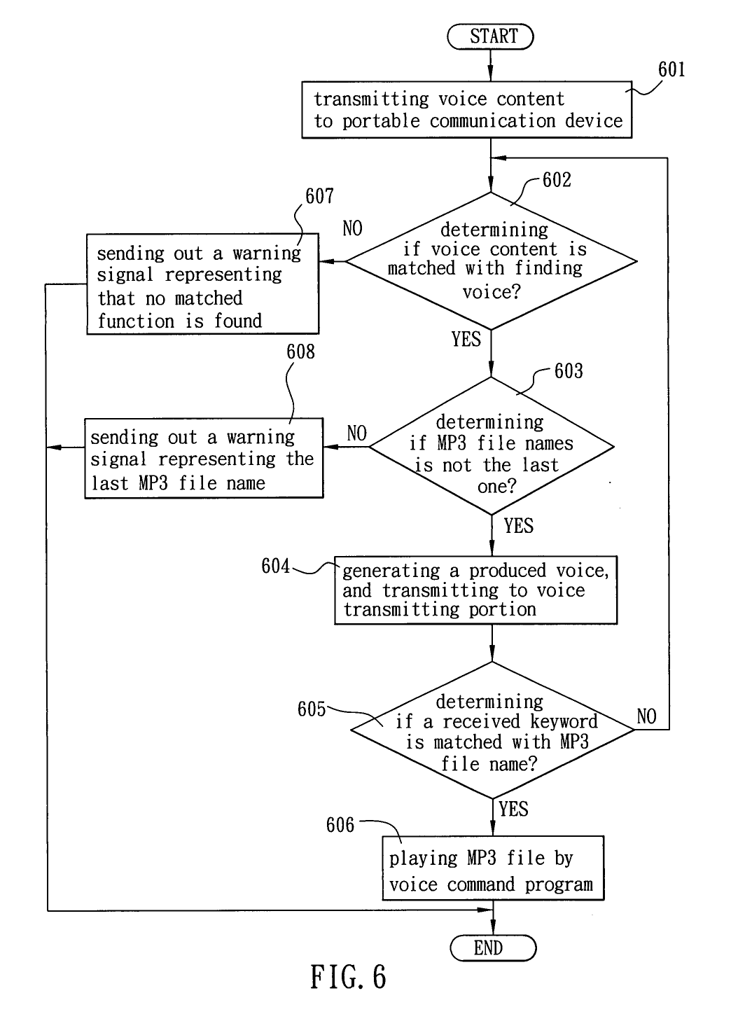

Referring back to FIG. 1, in a fifth preferred embodiment of the present invention, the wireless earphones 20 not only can be used to wirelessly drive the MP3 module 157 of the portable communication device 10 to play the MP3 file, but also can be used to find an MP3 filename stored in the MP3 file database 158 one by one. The speech program 153 can be used to compare the MP3 filenames of the MP3 file database 158 with a corresponding voice in turn, wherein the keywords are preferably selected from a finding voice. When the press key portion 25 is pressed and the voice command program 151 is executed, there are further several steps described more detailed as the following and shown in FIG. 6:

In step 601, the voice receiver 21 receives voice content, and then the voice content is transmitted to the portable communication device 10;

In step 602, the central processor 14 determines if the voice content is matched with the finding voice; if yes, go to step 603; if not, go to step 607;

In step 603, the speech program 153 determines if the MP3 filenames of the MP3 file database 158 is not the last one; if yes, go to step 604; if not, go to step 608;

In step 604, the voice command program 151 starts the speech program 153 to generate a corresponding produced voice according to the MP3 filenames of the MP3 file database 158, and the produced voice is transmitted to the voice transmitter 22;

In step 605, the central processor 14 determines if the voice receiver 21 receives a keyword matched with the MP3 filename; if yes, go to step 606; if not, go to step 602;

In step 606, the voice command program 151 converts the voice content into a voice command to play the MP3 file according to the path of the MP3 file, and finishes the MP3 procedure;

In step 607, the voice command program 151 sends out a warning signal representing that no matched function is found via the voice transmitter 22, and finishes the MP3 procedure; and

In step 608, the voice command program 151 sends out a warning signal representing that the last MP3 filename is accessed via the voice transmitter 22, and finishes the MP3 procedure.

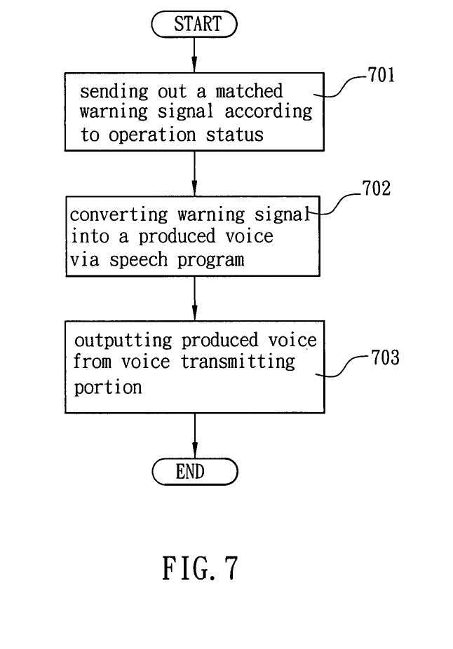

Referring back to FIG. 1, in a sixth preferred embodiment of the present invention, the voice command program 151 can send out the warning signal by generating a beep sound, a melody sound, or a MIDI sound via the voice transmitter 22. Alternatively, the voice command program 151 can send out the warning signal by generating a speaking voice via the voice transmitter 22. The storage unit 15 further comprises a warning signal database 159 which includes a plurality of warning signals, such as no matched function, no matched data, or the last data. The warning signals of the warning signal database 159 are sent out according to different operating modes via the voice transmitter 22. When the central processor 14 generates different determinations to respond to determined results of the voice command program 151, there are further several steps described more detailed as the following and shown in FIG. 7:

In step 701, the voice command program 151 sends out a matched warning signal according to different operating modes;

In step 702, the voice command program 151 starts the speech program 153, and converts the warning signal into a produced voice via the speech program 153; and

In step 703, the produced voice is transmitted to the wireless earphones 20, and outputted from the voice transmitter 22, so as to finish the warning procedure.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A wireless voice operated system for a portable communication device, comprising:
a wireless earphone including:
a voice transmitter for transmitting at least one voice content;
a voice receiver for receiving at least one voice content;
a wireless transmission module wirelessly connected to the portable communication device for transmitting the at least one voice content to the portable communication device; and
a control unit respectively connected to the voice receiver, the wireless transmission module, and a voice transmitter for controlling all of them, wherein the control unit receives the at least one voice message and sends it to the portable communication device via the wireless transmission module; and
the portable communication device including:
a wireless transmission portion wirelessly connected to the wireless earphone for receiving the at least one voice content;
a storage unit having a keyword database, a voice command program, and a plurality of function modules, wherein the keyword database is preset with
a plurality of voice commands for respectively starting the corresponding function modules, and wherein the voice command program starts one of the corresponding function modules according to one of the voice commands; and
a central processor for comparing one of the received at least one voice content with the voice commands, wherein the voice command program starts the corresponding function module according to the voice commands corresponding to the received at least one voice content.

2. The wireless voice operated system for the portable communication device of claim 1, wherein the portable communication device further includes a speech program for converting data of the portable communication device into a produced voice and transmitting the produced voice to the wireless earphones.

3. The wireless voice operated system for the portable communication device of claim 2, wherein the function modules includes a communication dialing module, the storage unit further includes a phone book database connected to the communication dialing module, and the phone book database stores at least one name data and at least one phone number corresponding to at least one name data.

4. The wireless voice operated system for the portable communication device of claim 2, wherein the function modules includes a MP3 module, the portable communication device further includes a MP3 file database connected to the MP3 module, and the MP3 file database is preset with at least one MP3 filename and at least one MP3 file path for accessing the corresponding MP3 filename.

5. The wireless voice operated system for the portable communication device of claim 2, wherein the wireless earphones further includes a press key portion which is pressed to send an instruction signal, the instruction signal is converted into a transmission signal via the wireless transmission module, and the transmission signal is sent to the portable communication device.

6. A wireless voice operating method for a portable communication device, comprising:
receiving at least one voice message transmitted from the wireless earphones by the portable communication device;
comparing the voice content with at least one voice command preset in the portable communication device by the portable communication device to confirm if the voice content is matched with the voice command; and
if yes, executing a function module corresponding to the voice command.

7. The wireless voice operating method for the portable communication device of claim 6, wherein the wireless earphones further includes:
a voice transmitter for transmitting at least one voice content;
a voice receiver for receiving at least one voice content;
a wireless transmission module wirelessly connected to the portable communication device for transmitting at least one voice content to the portable communication device; and
a control unit respectively connected to the voice transmitter, the voice receiver, and the wireless transmission module for controlling all of them, wherein the control unit receives at least one voice content and sends it to the portable communication device via the wireless transmission module.

8. The wireless voice operating method for the portable communication device of claim 7, wherein the portable communication device includes:
a storage unit having a keyword database, a voice command program, and a plurality of the function modules, wherein the keyword database is preset with a plurality of the voice commands for respectively starting the corresponding function modules, and wherein the voice command program starts one of the corresponding function modules according to one of the voice commands;
a wireless transmission portion wirelessly connected to the wireless earphones for receiving at least one voice content; and
a central processor for comparing one of the received voice content with the voice commands, wherein the voice command program starts the corresponding function module according to the voice commands corresponding to the received voice content.

9. The wireless voice operating method for the portable communication device of claim 8, wherein the function modules includes a communication dialing module, the storage unit further includes a phone book database connected to the communication dialing module, the phone book database stores at least one name data and at least one phone number corresponding to at least one name data, at least one name data respectively has a corresponding voice command, when the voice receiver receives one of the voice content, further comprising:
comparing the voice content with the voice command to confirm if the voice content is matched with one of the corresponding voice command;
if yes, comparing the voice command with the name data to confirm if the voice command is matched with one of the corresponding name data;
if yes, searching one of the phone number corresponding to the name data, and inputting the phone number into the communication dialing module; and
dialing the phone number by the communication dialing module.

10. The wireless voice operating method for the portable communication device of claim 9, further comprising:
sending out a warning signal representing that no matched name data is found via the voice transmitter, if the voice content is not matched with the voice command.

11. The wireless voice operating method for the portable communication device of claim 10, wherein at least one voice command further includes voice samples from 0 to 9, and a dialing voice, when the voice receiver receives one of the voice content, further comprising:
comparing the voice content with voice samples of 0-9 to confirm if the voice content is matched with one of the voice samples;
if yes, inputting the voice content to the communication dialing module by the voice command program, and then keeping receiving another one of the voice content;
if not, determining if the voice content is matched with the dialing voice; and
if yes, starting the communication dialing module to make a phone call according to the voice samples stored in the communication dialing module by the voice command program.

12. The wireless voice operating method for the portable communication device of claim 11, further comprising:
sending out a warning signal via the voice transmitter when the central processor determines that the voice content is not matched with the voice command.

13. The wireless voice operating method for the portable communication device of claim 12, wherein the warning signal is a speaking voice.

14. The wireless voice operating method for the portable communication device of claim 12, wherein the warning signal is a beep sound.

15. A wireless earphone, applied to a wireless voice operated system for a portable communication device, comprising:
a voice receiver for receiving at least one voice message;
a wireless transmission module wirelessly connected to the portable communication device for transmitting at least one voice content to the portable communication device;
a press key portion for being pressed to send out an instruction signal which is converted into a transmission signal via the wireless transmission module and sent to the portable communication device; and
a control unit connected to the voice transmitter, the voice receiver, the wireless transmission module, and the press key portion respectively for controlling all of them, wherein the control unit receives the at least one voice content, and sends the at least one voice content to the portable communication device via the wireless transmission module.
